(19) United States
(12) Patent Application Publication
(10) Pub. No.: US 2005/0160677 A1
(43) Pub. Date: Jul. 28, 2005

(54) Water-tight windows with preformed corners

(75) Inventors: Dale A. Gepfrey, Upland, CA (US); Gary L. Gepfrey, Dayton, OH (US)

Correspondence Address: Joseph G. Nauman, 696 Renolda Woods Ct., Dayton, OH, 45429-3415, US

(73) Assignee: Gephrey Industries, Inc.

(21) Appl. No.: 10/762,415

(22) Filed: Jan. 22, 2004

(51) Int. Cl. E06B 1/04

(52) U.S. Cl. 49/504

(57) ABSTRACT

A window construction applies to vertically or horizontally hung windows including horizontally sliding windows, to conventional double-hung windows wherein one or both sashes are movable, and to odd-shaped windows (hexagons, octagons, or the like). The outer window framework comprises lineal sections providing a header, a sill, and a pair of jambs, joined by formed corner sections of complementary cross-sectional configuration to achieve water-tight corner joints and a water-tight window. The outer framework incorporates flanges for mounting the complete window in a window aperture of a building or vehicle, and channels for receiving an inner framework of sashes and/or vents, and providing a peripheral seal for the same. She internal sashes may be single or multiple frames holding glass or comparable transparent or translucent panes. Sash frameworks likewise include a header, a sill, side posts (jambs), and (as needed) a peripheral or partial edge seal, which in use of sliding panes may require moving seal parts. The header, sill and jambs of both the outer window frame and internal sash sections are preferably lineal extrusions having cross-sectional configurations that are compatible with the profiles of preformed corner pieces. Preferred corner joints include a molded body with integral protruding splines that press fit into the ends of the lineal extrusion pieces with adjoining joint sealant to form a water-tight, rigid joint with a smooth exterior.

### FIELD OF THE INVENTION

This invention relates to a broad range of windows in Residential, Fabricated Housing, Recreation Vehicle (RV), and Commercial markets, wherein water-tightness, simplicity, rigidity, and long life are important, along with expense of parts and ease of fabrication, including assembly.

Windows in the Residential and Fabricated Housing markets are now constructed primarily of vinyl materials, which has risen above wood and aluminum as the most frequently used material. Conventional manufacturing of these vinyl windows is a complicated art that assembles various length pieces, sometimes with different extrusion profiles, after the header, jambs, and sill pieces have been miter-sawed with 45° angles, fabricated, and joined together through a heating and vinyl welding operation. This traditional approach to vinyl window manufacturing is a heavy user of saws, vinyl welding equipment, special fixtures, tables, multiple buffers of work-in-process inventories, material handling equipment and personnel, floor space, and energy (primarily electrical).

Even though vinyl windows have become the norm in the housing industry, aluminum windows with mechanically joined profiles are still used in these markets. Conversely, aluminum windows (often with a single piece frame and a U-shaped sash that are each bent to form radius corners) are still the window of choice in RV markets (mobile homes, travel trailers, fifth Wheel Units, and motor homes). The advantages of vinyl materials, including its better thermal performance properties, lower sound transmission, ease and uniformity of coloring, and enduring appearance have not been widely introduced or fully appreciated in these RV markets yet.

Thus, the general housing industry has been using vinyl windows with welded 90-degree corners for some time. The RV industry has not adopted these, even though a properly designed vinyl window would much improve thermal performance, sound performance, and provide lasting aesthetic appearance and functional endurance.

It is believed there is one major reason RV markets have not adopted vinyl windows. These markets prefer and specify windows with rounded, radius corners (for aesthetics and sleek, aerodynamic appearance) instead of windows with 90° corners. While manufacturing art exists for bending a single piece of aluminum to make a window with four radius corners, no manufacturing art exists or has been applied to make vinyl windows with water-tight radius corners. Vinyl can accommodate slight bends. However, it has not been bent and stretched like aluminum to form the market's desired radius corners. Additionally, the manufacturing art for bending aluminum windows is inherently a scrap-intensive process that wastes expensive aluminum material, especially during adjustment and prove-out of different machinery settings needed during frequent changeovers to different size windows.

In summary, there are opportunities to improve both the manufacturing art for vinyl windows with 90° corners used in residential and/or fabricated housing, and commercial building markets and in the manufacturing art for windows with radius corners used in RV markets. All these markets would benefit greatly with watertight, rigid, simple, vinyl windows that could be manufactured faster and more economically than today's current and complicated methods permit. This invention addresses these shortcomings and provides cost-saving manufacturing opportunities for these markets.

The following prior art, discovered in a preliminary search, has been considered; U.S. Pat. No. 3,784,043 of 1974, 4,296,587 of 1981, 5,473,853 of 1995, 5,809,901 of 1998, 5,921,037 of 1999, and 5,921,056 of 1999. While these disclose various forms of windows and/or fabricated frame and corner constructions, none disclose a water-tight system or window using pre-formed corners that provide a water-tight joint with lineal pieces to provide header, sill, and jambs, which is easier and less expensive to fabricate and build.

### SUMMARY OF THE INVENTION

The present invention provides a window construction which is applicable to all commercial building, vehicle, housing, and RV markets, or any other commercially known window. It applies to vertically or horizontally hung windows including (but not limited to), horizontally sliding (usually bypassing sashes) windows, to conventional double-hung windows wherein one or both sashes are movable, and odd-shaped windows (hexagons, octagons, etc.). The outer framework of most windows, according to the invention, comprises a header, a sill, and a complementary pair of side posts (jambs), which when assembled provide attachment parts for mounting the outer framework in a window aperture of a building or vehicle, and tracks for receiving the inner framework of a screen and one or more sashes and/or vents, and providing a peripheral seal for the same. The internal sashes may be single or multiple frames holding glass or comparable transparent or translucent panes. The sash frameworks likewise each include a header, a sill, side posts (jambs), and (as needed) a peripheral or partial edge seal, which in the case of sliding panes may require moving seal parts.

The header, sill, and jambs of both the outer window frame and internal sash sections may, according to the invention, have cross-sectional configurations to provide the necessary beam strength for such parts, and may include a variety of interior and/or exterior baffles, partitions, and the like to maintain structural rigidity and strength, to define closed or baffled sections for insulation purposes, lower sound transmittance, and/or for mounting convenience.

This concept of mating pre-formed corner pieces and lineal pieces, both having compatible cross-sectional profiles, to be water-tight can be accomplished with simple welding of these pieces. Or, the preformed corner pieces can have integral male spline configurations that provide a snug, mechanical fit when joined with lineal extrusions having compatible fermale profiles. While these approaches of welding and mechanically fitting preformed corners with lineal extrusions applies to windows made of a variety of materials, the preferred embodiments utilize a synthetic material, such as vinyl, which can readily be molded and/or extruded. In some exceptional cases, some windows made of vinyl may employ a combination of an extruded or molded vinyl profile with a metal stiffener to achieve required rigidity. Of paramount importance is the need to meet or exceed the rigidity and wear resistant requirements of a go, water-tight, weather-resistant window while using designs (especially in cross-section) that can be extruded to various lengths and provide needed strength in the applicable material.

Therefore, the header, sill, and jambs making up the internal sash and outer window frameworks are usually lineal hollow extrusions, and in most cases, the corners where these linear extrusions are joined are at 90° to form a polygonal structure, usually rectangular. A minor exception to this would be in the case of other polygonal windows, i.e. hexagonal or octagonal window shapes (i.e. a “Picture Window”), to which the principles of the present invention can also be applied.

In the case of windows made with vinyl, plastic, rubber, or a composite material to join the header, sill, and side posts of the frameworks, the invention provides molded corner pieces having integral spline configurations (male protrusions) extending from their ends which are matched to, e.g. are of complementary cross-sectional shape to, the ends of the linear headers, sills, and jambs. The spline shapes at each end of these molded corners can be an identical or distinct configuration because they are formed as molded parts. Similarly, the corner pieces can also have a radius configuration, or an angular configuration, because they are formed as molded parts.

The precision of molding manufacturing processes provides that the spline sections at opposite ends of the corner pieces are the precise configuration, including the desired size and shape for mechanically joining the extruded lineal parts. This includes (but is not limited to) spline configurations with tapered angles, snap-in tabs, and other methods of mechanically joining the corner and lineal pieces (i.e. components). In complementary window applications, molded corners can be joined un-mechanically to straight lineal pieces via other joining methods, such as vinyl welding or sonic welding to achieve required rigidity and water-tightness. Regardless of the synthetic or natural materials (including vinyl, plastic, rubber, composites, and any other material) used, the invention calls for mating formed corner pieces to the exterior of the ends of adjoining lineal parts (headers, jambs, and sills) because the lineal extrusions and the formed parts (corner pieces) can be fabricated of the same or compatible material, and the color thus is consistent, the exteriorly visible joint is smooth and essentially linear, and the window is water-tight and rigid.

In many cases, all the outer window framework pieces and their complementary internal sash pieces can be made of the same material and few profiles, thus keeping the number of various shapes required to a minimum. Sizes of such windows can readily be varied simply by using different length lineal extrusion pieces to make the required heads, jambs, and sills. And in some cases, required fabrications (weep holes, notches, piercings, balancer hooks, positioning blocks, etc.) can be an integral design of the molds and formed in the corner pieces, thus avoiding secondary manufacturing or assembly operations.

Other objects and advantages of the invention will be apparent from the following description, the accompanying drawings, and the appended claims.

### BRIEF DESCRIPTION OF THE DRAWINGS

FIG. 1 shows a window incorporating the features of the invention installed in a house or commercial structure;

FIG. 2 is an exploded perspective view of a window, including an outer frame and internal sash, incorporating the features of the invention as it applies to corner pieces with integral spline configurations;

FIG. 3 shows a molded 900 corner with identical spline configurations at each end that mate with identical lineal extrusions for the main frame and sash, respectively;

FIG. 3A highlights the identical main frame profits and sash profiles used in all sections of the window, including the head, sill, jambs, and 90° corner pieces.

FIG. 4 shows a molded radius corner with distinct spline configurations at each end that mate with distinct lineal extrusions in both the main frame and sash;

FIGS. 4A and 4B highlight the differences in cross-sections of the right jamb and sill pieces and their corresponding spline ends in the molded, water-tight radius corner pieces;

FIG. 5 shows how the invention applies to RV windows, wherein rounded corner pieces are joined to lineal extrusion pieces via a process of manual press fitting and application of a joint sealant for a water-tight window assembly;

FIG. 5A shows a cross-section of the lineal extrusions embodying a sloped surface for directing water to the window exterior;

FIG. 6 shows another way the invention is applied in RV window applications, wherein the rounded corner pieces, having a different yet compatible profile, are joined to lineal extrusion pieces with methods such as vinyl or sonic welding to achieve a water-tight window assembly,

FIG. 6A shows the distinct end configuration of the lineal extrusion pieces used for the sill, jambs, and head of the window featured in FIG. 6;

FIG. 6B shows the integral end configuration of the molded, rounded corner pieces, which differs from the complementary profile of the lineal extrusion pieces;

FIG. 7 shows a molded section with an acute angle that joins with straight lineal extrusion pieces to form an uncommon shaped polygonal windows such as hexagons and octagons, which can be accomplished with welding or with a manual press fitting and joint sealant operation;

FIG. 8 shows a pre-formed (die cast) metal corner (aluminum) with an integral spline configuration that mates mechanically with lineal extrudates and uses seam sealant to achieve a water-tight window assembly; and

FIG. 8A is a cross-section of the lineal extrusions shown in FIG. 8.

### DESCRIPTION OF PREFERRED EMBODIMENTS

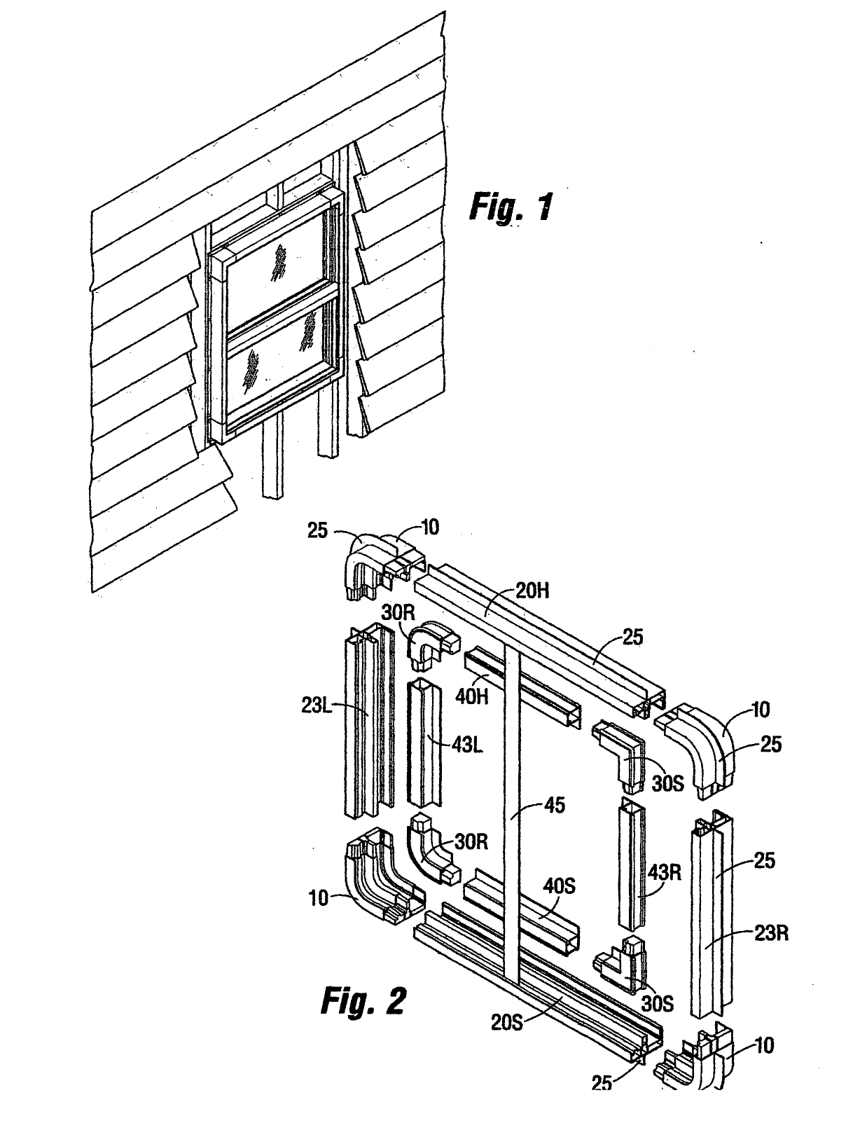

The window construction provided by the present invention is particularly applicable to vertically or horizontally hung windows, to horizontally sliding (usually bypassing panes) windows, to conventional double-hung windows wherein one or both sashes are movable, and to fixed windows in all types of polygonal shapes. For purposes of explanation, a window having a sliding sash, and constructed with radius (curved) corners, is shown in FIG. 2. The outer portion (frame) of the window, according to the invention, comprises a header 20H, a sill 20S, and complementary side-posts (iambs) 23L and 23R, which are extrusions of plastic, vinyl, rubber, or some composite of natural and/or synthetic material having customized cross-sectional configurations which are designed to impart adequate beam strength to the linear extrusions. The internal portion (sash) of the window also has a header 40H, a sill 40S, and complementary side-posts (jambs) 43L and 43R. For interlocking purposes, there is a frame meeting rail 45.

An important feature of the invention is the provision of formed (e.g. molded), water-tight corner pieces 10 for the exterior window framework, and for the internal sash framework and its corner pieces 30R and 30S. These corner pieces, because they are a formed part, usually molded, can have a radius configuration, or an angular configuration from 0 to 360 degrees, something that is quite time consuming to do by bending various metal extrusions used in prior art window constructions or when welding two separate lineal pieces, each with angled cuts. Recall that, in the case of vinyl windows, present manufacturing art and technologies are limited to making slight, gradual bends, not forming or bending of a 90° radius corner, which is the window profile of choice in RV markets. This is also true of other plastic, rubber, synthetic, or composite material.

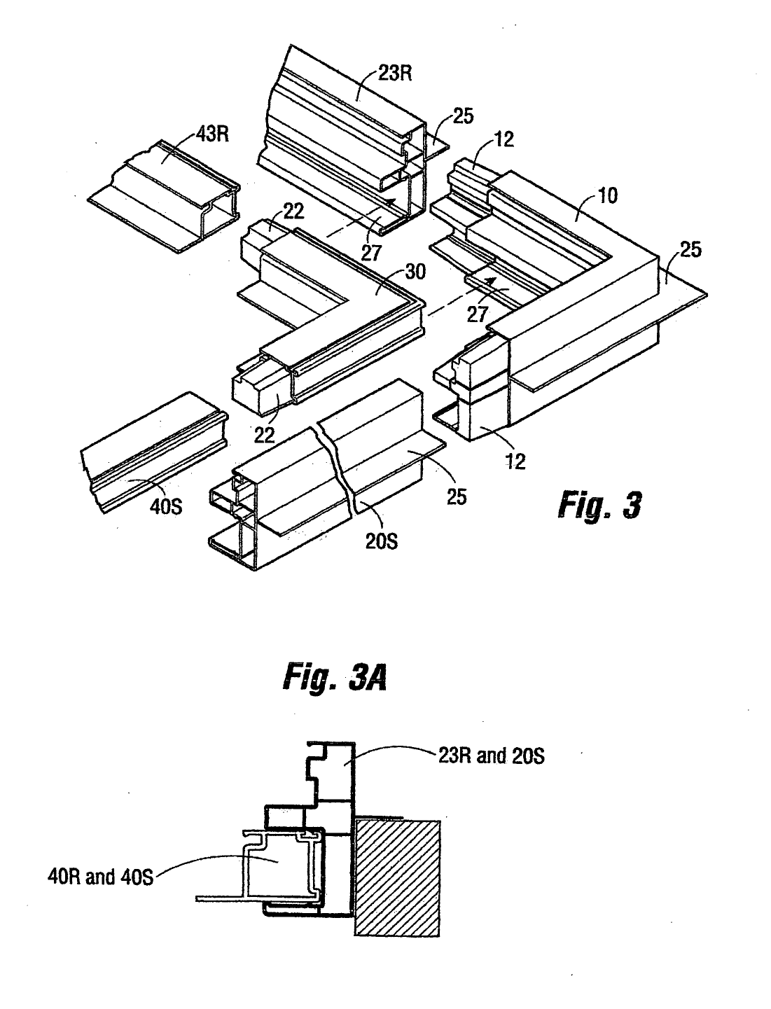

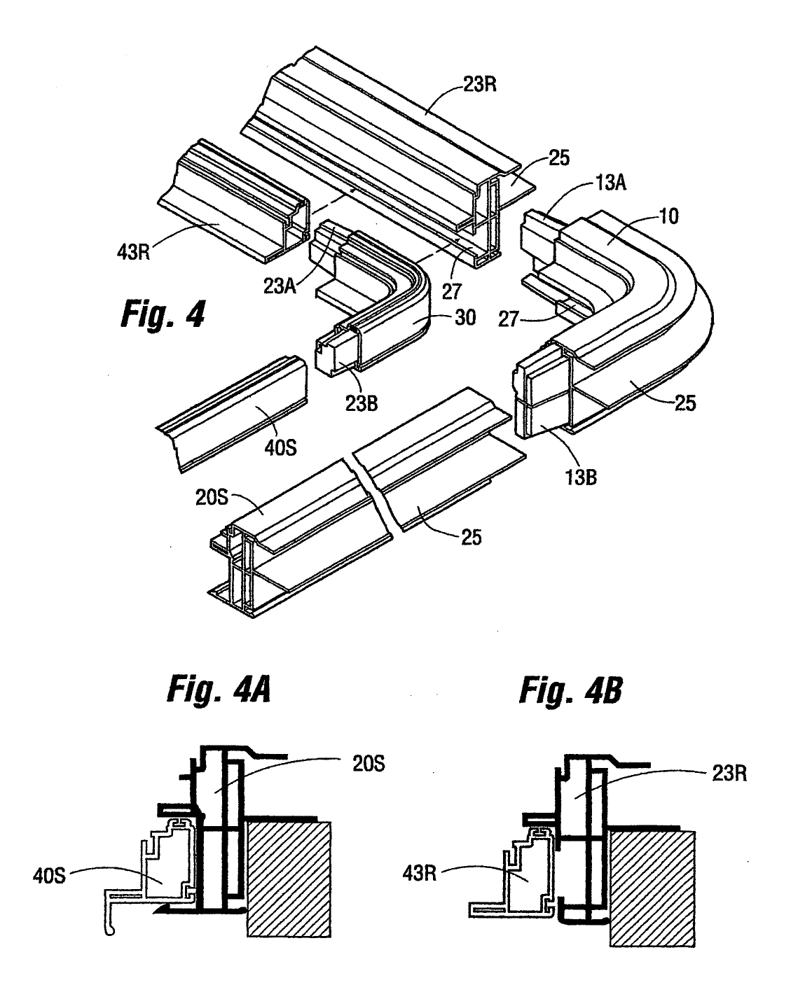

FIG. 3 shows a window configuration wherein the exterior frame corners 10 have identical spline configurations 12, and the interior sash corners 30 have identical spline configurations 22. FIG. 4 shows a different window design. It features a window sill 20S with a profile that differs from the extruded lineal profiles 23R used for the Left and Right jambs and the head. As such, the corner pieces of this main window frame require formed pieces with a different spline configuration at each end 13A and 13B. Additionally, the sash profiles 40S and 40R, as illustrated in FIGS. 4A and 4B, show distinct contours. Even so, the spline configurations 23A and 23B have identical shapes at each end of the sash corner pieces 30 because one shape fits both sash profiles. FIGS. 4A and 4B also show the distinctive differences of the sill and jamb profiles, which require corner pieces 10 with different male spline configurations 13A and 13B to mate with each lineal extrusion piece. In both FIGS. 3 and 4, the external cross-sectional configuration of each spline is of a complementary cross-sectional shape to their mating lineal sections (headers, sills, and jambs).

As will also be noted in FIGS. 2, 3, 4, 6, and 7, the inward facing surfaces of the frame window sections (corners, headers, jambs, and sills) include profiled walls that serve as channels 27 within which the sash or inner framework can slide. Note also the outer flanges 25 of the frame sections. They are used for mounting the outer framework in a window aperture of a commercial building, a residence or a prefabricated house, or a recreation vehicle.

The inward facing surfaces of tracks 27 receive the sash framework and provide a peripheral seal for any moving components. The sash framework(s) may be single or multiple members, holding glass or comparable transparent or translucent panes, which can be fastened therein by any type of conventional, marine, drop-in, or other commercially known glazing methods. The sash framework(s) likewise each include a header, a sill, jambs, and (as needed) a peripheral or partial edge seal, which in the case of sliding panes may require moving seal parts.

With respect to pre-formed, water-tight corner pieces, the configurations of splines at each end of the corner pieces feature various shapes and sizes, sometimes with tapered, angular profiles to facilitate a process of manual press fitting and joint sealant application to achieve a complete, water-tight, and rigid window assembly when joining corners to the extruded lineal pieces. In some cases, the mere mechanical fit provides the window's needed rigidity and water-tightness. In other cases, a suitable sealant can be used to form a secure bond in these joints to achieve a watertight framework. The joints can also be joined via vinyl welding, sonic welding, or other suitable joining methods.

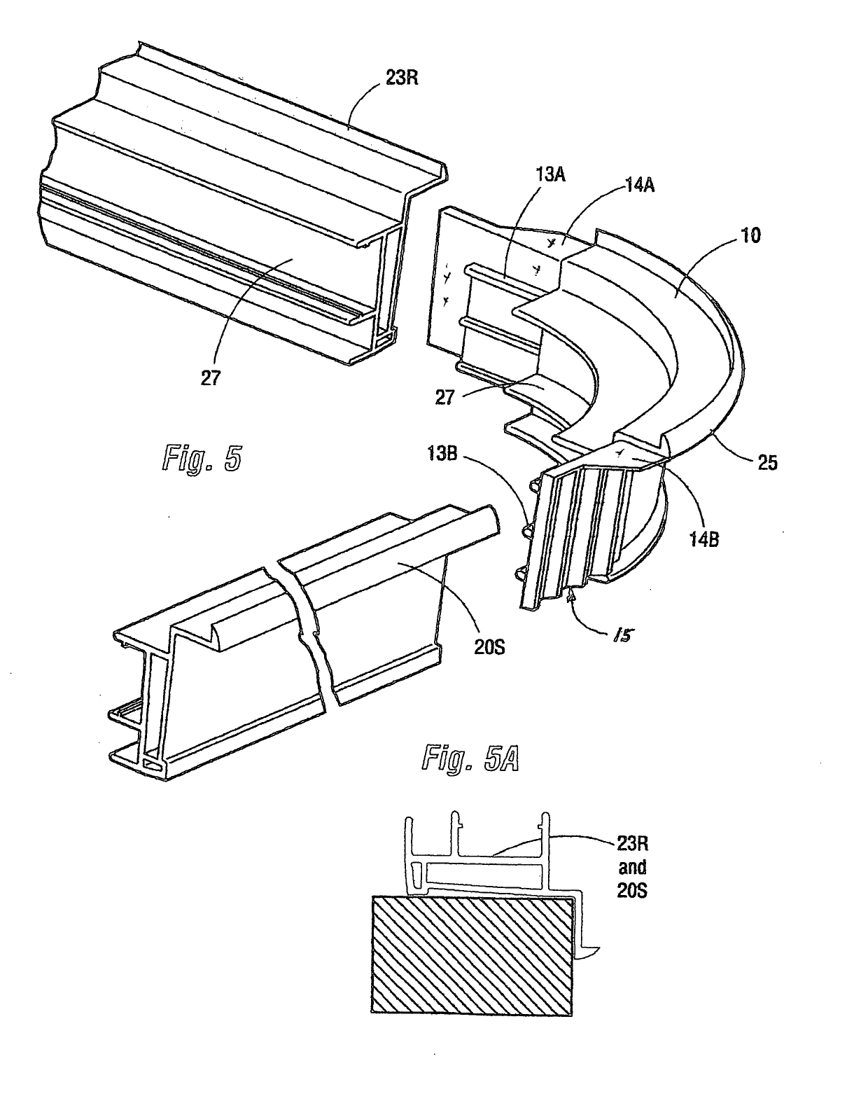

FIG. 5 shows one way the invention can be applied in RV window applications that require rounded corners. The primary spline configurations 13A and 13B feature an identical size and shape, each providing a snug, secure fit when fully inserted into the extruded lineal parts. The secondary spline configurations 14A and 14B are considered “lapping and positioning splines” that serve two major functions: 1) to provide a physical overlap (corner section over the lineal piece) to help secure the physical connection of both pieces and facilitate the application of a joint sealant to establish a water-tight joint, and 2) to provide built-in positioning block sections 15 to facilitate easy mounting of window inside RV openings/frames. This built-in feature eliminates separate operations to make, fabricate, and apply these required positioning blocks to RV windows.

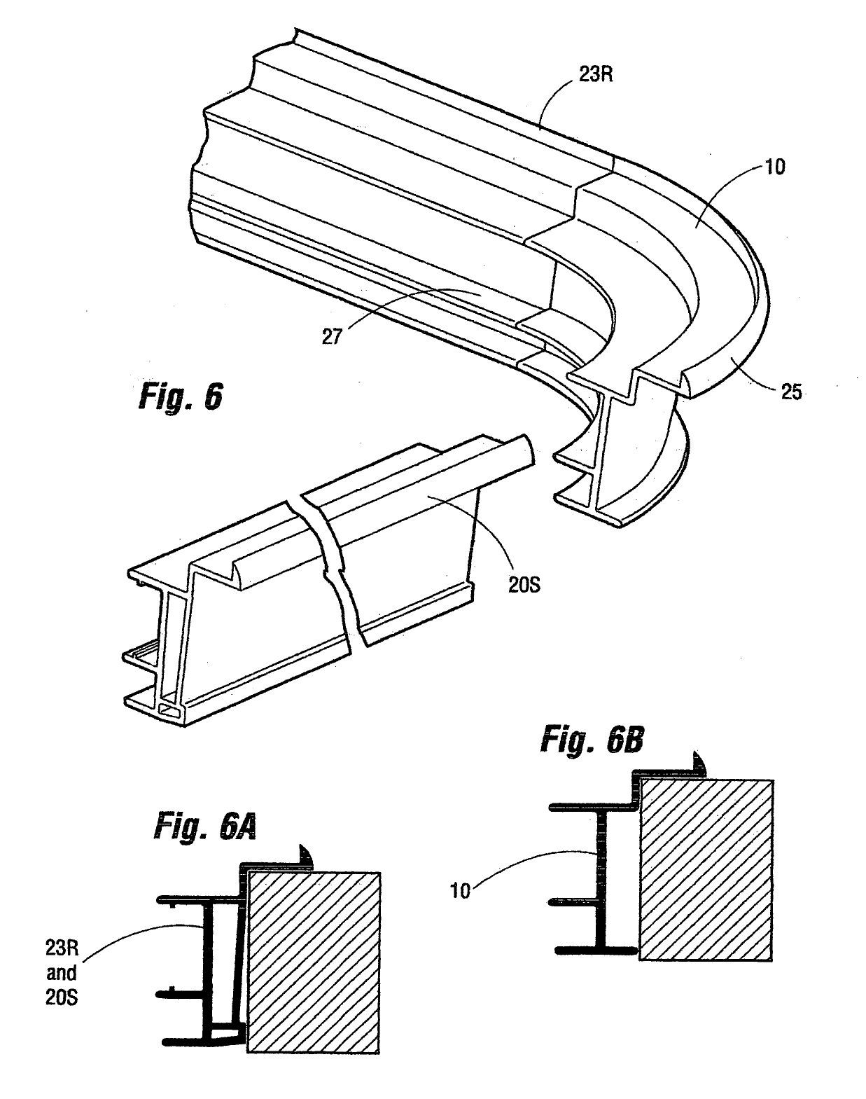

FIG. 6 shows a window without integral spline configurations, wherein the formed corner pieces 10 are joined through conventional heating and welding, sonic welding, or similar joining process. Note the cross-sectional profile differences between the lineal extrusion pieces and the formed corners. While different, the shapes of each profile are each designed to be extrusion-friendly and mold-friendly while conserving the amount of material used in each profile. With complementary cross-section shapes, these different pieces can be attached via various welding and similar joining processes to achieve a secure, water-fight joint. FIG. 7 shows how the invention applies to uncommon windows. Pre-formed pieces, preferably molded, provide acute angles 50 that can be joined to other pieces, such as lineal sections 23R of the exact length needed to build windows with more than four sides.

To conclude, in all these window applications, the exterior configuration of the formed pieces is matched to the exterior of the ends of the joined lineal parts, such that the exteriorly visible joint is smooth, essentially linear, and water-tight. Also, the lineal extrusions and formed corner pieces can be constructed with precisely matched color by using vinyl or any other material that permits joining extruded and formed pieces. Thus, embodiments using vinyl or like plastic materials are preferred.

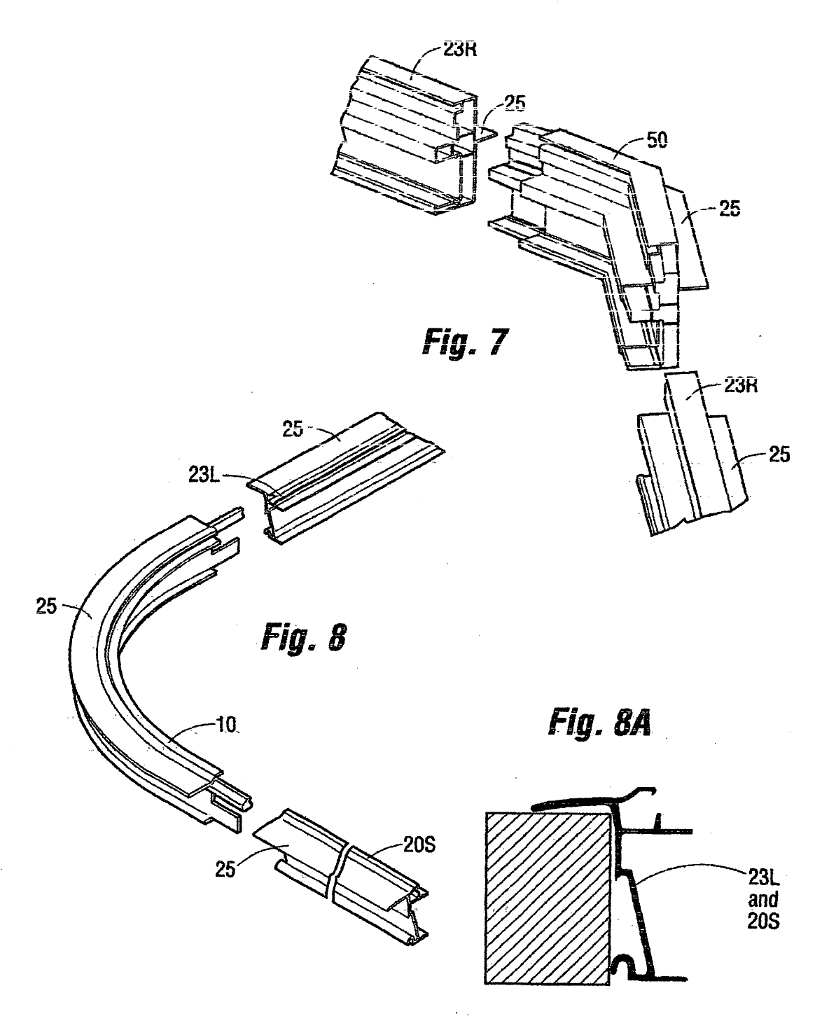

However, it should be recognized that for some types of construction, the features of this invention may be applied to metal, such as aluminum, which can be roll formed into certain shapes and/or extruded to create specified profiles. These metal lineal pieces can also fit and be joined with formed corners made by casting processes. FIG. 8 illustrates such an embodiment.

While the methods herein described, and the forms of windows made by these methods, constitute preferred embodiments of this invention, it is to be understood that the invention is not limited to these precise methods and forms of windows and parts thereof, and that changes may be made in either without departing from the scope of the invention, which is defined in the appended claims.

### Reference Number List

10 preformed corner pieces
12 identical spline configurations
15 window positioning blocks
20H main frame header
20S main frame sill
23L & 23R left and right main frame jambs or side posts
25 main frame window mounting flanges
27 main frame sash channels
40H sash header
40S sash sill
43L & 43R left and right sash jambs
45 main frame meeting rail
50 acute angle main frame pieces

1. A window construction comprising
an exterior frame including at least four integrally formed frame corners and at least four lineal rails joined between said frame corners to define the exterior shape of the frame outer edges and the shape of the edges of an interior opening surrounded by the frame, the lineal rails providing the header, sill, and jambs of the frame;
the joints of said formed corners and rails having water-tight rigid joint sections which present a smooth exterior at least on the exteriorly visible parts of the joints,
said corners and rails also having integral exterior frame flanges extending outward thereof for attachment of the assembled window into a window aperture,
said corners and rails having at least one frame channel extending about the interior opening to receive and support a window pane, and
said rails and corners being formed from essentially the same material.

2. A window construction as defined in claim 1, wherein said joint sections have closely interfitting spline sections which form the rigid water-tight joint.

3. A window construction as defined in claim 2, wherein a sealant is added to the joint sections as they are assembled to form a water-tight joint.

4. A window construction as defined in claim 2, wherein said joint sections comprise male spline fittings of predetermined irregular external cross-section on said frame corners and said lineal extrusion pieces having essentially matching internal cross-section to receive said male splines of said formed frame corners.

5. A window construction as defined in claim 1, wherein said joint sections have compatible mating profiles that are joined by welding to form a water-tight joint.

6. A window construction as defined in claim 1, 2, 3, 4 or 5, wherein said frame channel receives the edges of a sash construction,
said sash construction including at least one set of four sash lineal pieces and at least four integral formed sash corners joined to define at least one sash frame dimensioned to fit within said frame channel,
said sash lineal pieces and formed sash corners defining the exterior shape of the sash frame outer edges to conform to the channels, and also defining the shape of the edges of an interior opening surrounded by the frame, said lineal pieces providing the header, sill, and jambs of the sash frame;
said sash lineal pieces and corners forming a sash channel to receive a window pane within the sash frame,
at least one of said sash frames being movable along its channel such that the jambs of the two sashes overlap and close the interior opening of the exterior frame, and to positions along its channel wherein the window is partially opened.

7. The window construction defined in claim 6, wherein both sashes are movable.

8. A window construction as defined in claim 6, wherein said sash lineal extrusion pieces and integral formed corners are produced from compatible materials as the exterior window frame.

9. A window construction as defined in claim 6, wherein the sashes include sash joint sections having closely interfitting spline sections which form the water-tight joint.

10. A window construction as defined in claim 9, wherein said sash joint sections comprise male spline fittings of predetermined irregular cross-section on said integral formed sash corners and said sash lineal rails having essentially matching internal cross-section to receive said male splines of said integral formed sash corners.

11. A window construction as defined in claim 5, wherein the lineal pieces are extruded of a synthetic material and the integrally formed corners are molded of compatible synthetic materials.

12. A window construction as defined in claim 5, wherein there are multiple separate channels in the exterior window frame, and one of said channels is adapted to receive a frame carrying a screen and/or an insulating window pane.

13. A window construction as defined in claim 5, wherein at least the sill has an outwardly and downwardly sloped surface to drain moisture to the exterior of the window frame.

14. The method of constructing a window comprising the steps of,
a) building an exterior frame from at least four formed integral frame corners of synthetic material and at least four lineal rails joined between the frame corners to define the exterior shape of the exterior frame outer edges and the shape of the edges of an interior opening surrounded by the frame, whereby the rails provide the header, sill, and jambs of the window frame;
b) molding the corners and extruding the lineal extrusion pieces from compatible synthetic materials and including integral main frame flanges extending outward thereof for attachment of the assembled window into a window aperture, and
c) forming on the corners and on the lineal rails at least one frame channel extending about the interior opening to receive and support a window pane.

15. The method of claim 14, comprising the additional steps of,
d) forming joint sections comprising male splines and shrouds of predetermined irregular cross-section on the corners, and
e) forming the lineal rails so as to have essentially matching internal cross-sections to receive the male splines and overlapping shrouds of said formed corners, and
f) joining the male spline-fittings and shrouds into the matching internal cross-sections of the lineal rails to form rigid water-tight joints.

16. The method of claim 14, comprising the additional steps of,
g) in step (c) forming at least one frame channel in the lineal rails and in the corners, which channels are aligned to receives the edges of a sash construction,
h) forming a sash construction including at least one set of four sash rails and at least four integrally formed sash corners,
i) joining the sash lineal rails and sash corners to define at least one sash frame dimensioned to fit within the channel, whereby the lineal sash rails and formed sash corners define the exterior shape of the sash frame outer edges to conform to the frame channel, and also define the shape of the edges of an interior opening surrounded by the frame,
j) mounting the sash in the frame channel.

17. The method defined in claim 14, wherein the formed corners and the lineal rails are formed of a vinyl material.

18. The method defined in claim 14, welding compatible mating profiles of joint sections to form rigid water-tight joints.

19. An integrally formed corner section for a window framework, comprising
a central body having diverging end sections arranged at a predetermined angle to each other,
said end sections including protruding male splines extending from said end sections and aligned at a predetermined angle to each other and having a predetermined irregular cross-section which will fit closely within the ends of lineal rails of the framework to establish rigid finished water-tight corners of the framework.

20. A formed window corner section as defined in claim a 19, wherein
said male splines are provided with predetermined irregular cross-section which match openings at the ends of lineal rails having essentially complementary internal cross-section to receive said male splines of said formed corners and form a rigid water-tight joint.
